(19) United States
(12) Patent Application Publication
(10) Pub. No.: US 2007/0069089 A1
(43) Pub. Date: Mar. 29, 2007

(54) License plate frame with vacuum base mount

(76) Inventor: James Christopherson, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 11/234,256

(22) Filed: Sep. 23, 2005

(51) Int. Cl. F16B 47/00

(52) U.S. Cl. 248/205.5

(57) ABSTRACT

Embodiments of the present invention relate to a license plate vacuum mount for securing a license plate to a vehicle. The license plate vacuum mount may include a license plate frame and a vacuum base mount. The vacuum base mount may supply a suction force against an adjacent surface of a vehicle body that is sufficient to secure the license plate vacuum mount at a desired location on the vehicle. The license plate frame is configured for securing or attaching a license plate against the license plate vacuum mount through the use of mechanical fasteners, adhesives, magnets, or hook and loop material, among others. Alternatively, the license plate frame may have a pouch or envelope configuration that allows the license plate to be slid into the license plate frame from the top, bottom, or side of the license plate frame.

### BACKGROUND OF THE INVENTION

Embodiments of the present invention relate to a license plate vacuum mount for securing a license plate to a motorized or towed vehicle. More specifically, the present invention relates to a license plate frame that is connected to a vacuum base mount that may be mounted to a vehicle. The present invention allows for the efficient mounting and dismounting of a license plate frame to a motorized or towed vehicle without scratching or damaging the finish, paint, and/or body of the vehicle.

Many types of different vehicles, such as automobiles, trailers, and motorcycles, that travel or enter onto roadways are legally required to have state issued license plates that have identification letters and/or numbers that may provide information identifying that particular vehicle and its owner. However, in many types of commercial activities, license plates, and the associated identification information, have not yet been assigned to each and every vehicle. In those instances, temporary license plates may be mounted onto the vehicle so that the vehicle may travel or enter onto the roadways. For example, new and used car dealerships often have state issued dealer license plates that may be temporarily mounted onto an automobile when a prospective buyer takes the automobile onto the roadways for a test drive.

Many license plates and vehicles, or associated housings or frames attached to the vehicle, have four pre-drilled holes that may be used to mount the license plate to the vehicle. These holes, which are typically located in proximity to the corners of the license plate, allow for the passage of bolts or screws through both the license plate and a portion of the vehicle. After at least one bolt or screw is positioned through the license plate (and possibly a license plate face plate or cover) and vehicle, a mating nut(s) may be placed on the end of the bolt(s) or screw(s). The combination of the bolt or screw and nut may then be tightened to securely mount the license plate to the vehicle.

However, installing the relatively small bolts or screws and nuts is time consuming. For example, in the car sales environment, the sales person often has to retrieve a mechanic or additional personnel who is then required to come out to the vehicle with his/her tools, and begin to secure at least two bolts or screws and nuts to the license plate and car so as to properly secure the temporary license plate. Then, when the test ride has concluded, the mechanic or additional personnel is required to come back out to the vehicle and remove the same bolts or screws and nuts in order to dismount the temporary license plate. Besides being time consuming, each time the license plate is mounted and dismounted from the vehicle by applying or removing the combination of bolts or screws and nuts, the chances that finish, paint, and/or body of the vehicle may be scratch or damaged increases. For example, the placement of the metallic material of the license plate against the body of the vehicle may scratch the vehicle's paint or finish. The tightening of the bolts or screws and nuts, or an accidental slip of a wrench or screw driver, may also scratch or ding the vehicle.

As an alternative to using bolts or screws and nuts to secure license plates to vehicles, some license plates have been temporarily attached to vehicles through the use of magnets. In such applications, the magnets may be placed between the back of the license plate and the vehicle. However, the surface of the vehicle to which the magnet attaches must also be metallic in order for the license plate to be securely mounted to the vehicle. Yet, many of today's newer cars are being constructed from non-metallic materials, such as plastics and composites, which may prohibit the use of magnets in mounting the license plate to the vehicle. Further, when used, the metallic surface of magnets may also scratch or damage the finish, paint, and/or body of the vehicle.

Other systems rely on license plate frames that have a group of strategically placed individual suction cups. The license plate frame of such devices may be configured to form a pocket or envelope through which the license plate may be inserted. However, in such systems, proper installation requires that each individual suction cup provide a suction force against the vehicle. This may require the wetting of each individual suction cup and/or pressing the area about each suction cup to ensure that desired engagement between the suction cups and the vehicle is achieved. Disengagement of the suction cups may also require that the license plate be pulled at various locations to ensure the suction force of each individual suction cup is breached before the system may be removed from the vehicle. However, because the suction force of all suction cups may be breached at the same time, those suction cups retaining their suction force may cause the license plate frame that is being pulled away from the vehicle to recoil back towards the vehicle, which may result in damage to the paint and/or finish of the vehicle. Further, when removed, each suction cup may leave its own separate mark on the vehicle that requires cleaning.

Thus, a need exists for a system for mounting a license plate to a vehicle that prevents damage to the finish, paint, and/or body of the vehicle. Overall, a need exists for an efficient system for repeatedly temporarily mounting and removing a license plate from vehicles.

### BRIEF SUMMARY OF THE INVENTION

Embodiments of the present invention relate to a license plate vacuum mount for securing a license plate to a vehicle. The license plate vacuum mount may include a license plate frame and a vacuum base mount. The vacuum base mount may supply a suction force against an adjacent surface of a vehicle body that is sufficient to secure the license plate vacuum mount at a desired location on the vehicle. The license plate frame is configured for securing or attaching a license plate against the license plate vacuum mount through the use of mechanical fasteners, adhesives, magnets, or hook and loop material, among others. Alternatively, the license plate frame may have a pouch or envelope configuration that allows the license plate to be slid into the license plate frame from the top, bottom, or side of the license plate frame. A cover may also be secured against the license plate and to the license plate vacuum mount.

### BRIEF DESCRIPTION OF SEVERAL VIEWS OF THE DRAWINGS

FIG. 1 illustrates an exploded view of a license plate vacuum mount, license plate, and cover according to an embodiment of the present invention.

FIG. 2 illustrates a side elevational view of the license plate vacuum mount, license plate, and cover according to an embodiment of the present invention.

FIG. 3 illustrates a rear elevational view of the license plate vacuum mount, license plate, and cover according to an embodiment of the present invention.

FIG. 4 illustrates a front elevational view of the license plate vacuum mount, license plate, and cover according to an embodiment of the present invention.

The foregoing summary, as well as the following detailed description of the preferred embodiments of the present invention, will be better understood when read in conjunction with the appended drawings. For the purpose of illustrating the preferred embodiments of the present invention, the drawings depict embodiments that are presently preferred. It should be understood, however, that the present invention is not limited to the arrangements and instrumentality shown in the attached drawings.

### DETAILED DESCRIPTION OF THE INVENTION

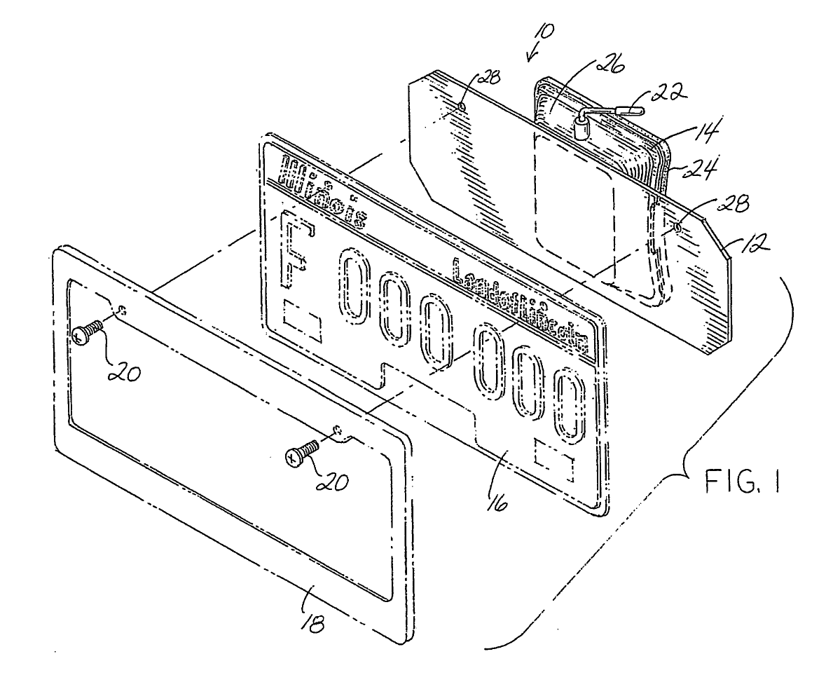

FIG. 1 illustrates an exploded view of a license plate vacuum mount 10, license plate 16, and cover 18 according to an embodiment of the present invention. The license plate vacuum mount 10 may include a license plate frame 12 and a vacuum base mount 14. The vacuum base mount 14 may include a lever 22, a suction pad 24, and a housing 26. The vacuum base mount 14 may be a standard commercially available vacuum base, such as those commonly used on pencil sharpeners, vices, and other tools that allow for securely mounting those products at the desired position or location.

The suction pad 24 of the vacuum base mount 14 may be placed against the desired location on the vehicle. For instance, the suction pad 24 may be placed against a relatively smooth and non-porous portion of the vehicle in the region configured for placement of the license plate 16. The lever 22 may then be turned or flipped so as to manually create a suction force in the area generally adjacent to the suction pad 24. The suction force created may be strong enough to securely mount the license plate vacuum mount 10 and any attached license plate 16 to the vehicle. To deactivate the suction force, the lever 22 may again be manipulated to cause a breach in the suction force between the suction pad 24 and the adjacent portion of the vehicle body, and thereby allow the removal of the license plate vacuum mount 10 away from the vehicle.

The license plate frame 12 may be operably attached to the housing 26 of the vacuum base mount 14, such as, but not limited to, through the use of mechanical fasteners, weld(s), or adhesives. In the embodiment illustrated in FIG. 1, the license plate frame 12 is a plate that has at least one aperture 28 that is configured to aid in securing the license plate 16 to the license plate frame 12, such as through the use of fasteners 20. However, the license plate 16 may be secured to the license plate frame 12 through the use or a variety of fasteners or adhesive materials, including, foldable or rotatable arms or claps, magnetic force, or hook and loop material.

FIG. 1 also illustrates the inclusion of a cover 18. As shown, the cover 18 may be attached to the license plate vacuum mount 10 through the use of the same fasteners 20 that attach the license plate 16 to the license plate frame 12. However, alternatively, the cover 18 may be attached to the license plate frame 12 through separate mechanical fasteners. Additionally, the cover may have slots, grooves, rails, or extensions, that fit, slid, or engage with mating counterparts in the license plate frame 14 that create a secure connection between the cover 18 and license plate frame 14 that may also securely hold the positioning of the license plate 16 along at least a portion of the license plate vacuum mount 10. Further, although the cover 18 is illustrated in FIG. 1 as covering only a portion of the face of the license plate 16, an at-least semi-translucent cover 18 may also be configured to cover the entire face of the license plate 16.

In the embodiment shown in FIG. 1, the license plate frame 12 is shown to have a configuration similar to a plate. However, in alternative embodiments, the license plate frame 12 may have a variety of different configurations, including, but not limited to, a bracket, ornamental shape, and a T-shape. Further, the license plate frame 12 may also have a pouch or envelope configuration, which is shaped to allow the license plate 16 to be slid into the license plate frame 12 from the top, side, or bottom of the frame 12. A pouch or envelope configuration would also include at least one opening through which at least a portion of the identification information on the license plate 16 would be readily visible. The license plate frame 12 may be constructed from a variety of materials, including metals and plastics.

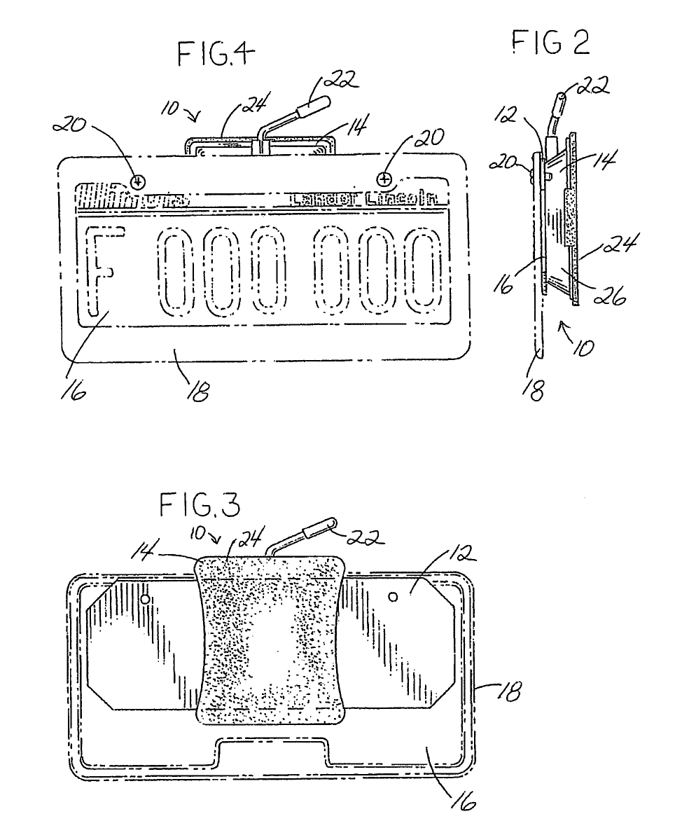

FIG. 2 illustrates a side elevational view of the license plate vacuum mount 10, license plate 16, and cover 18 according to an embodiment of the present invention. As shown in FIG. 2, the license plate frame 12 is positioned against the housing 26 of the vacuum base mount 14. In the embodiment illustrated in FIG. 2, the license plate 16 is secured against the license plate frame 12 through the use of fasteners 20. Additionally, as shown, the license plate frame 12 may be configured so as to allow for access to, and manipulation of, the lever 22.

FIG. 3 illustrates a rear elevational view of the license plate vacuum mount 10, license plate 16, and cover 18 according to an embodiment of the present invention. In the embodiment illustrated in FIG. 3, the license plate frame 12 is configured to not extend beyond the sides of the license plate 16. Such a configuration not only may save money in material cost, but also may reduce the risk that, when being positioned with a license plate 16 against the body, the license plate frame 12 does not accidentally scratch or damage the paint or finish of the vehicle.

FIG. 4 illustrates a front elevational view of the license plate vacuum mount 10, license plate 16, and cover 18 according to an embodiment of the present invention. As shown, the cover 18 and license plate 16 may be secured by the same fasteners 20 to the license plate vacuum mount 10. The lever 22 may also be readily accessible for efficient engagement and disengagement of the suction pad 24 with the vehicle.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A license plate vacuum mount for efficiently securing a license plate to a vehicle comprising:
a vacuum base mount, the vacuum base mount having a lever, a suction pad, and a housing; and
a license plate frame operably attached to the vacuum base mount, the license plate frame configured to operably secure the license plate to the license plate vacuum mount.

2. The license plate vacuum mount of claim 1 wherein the license plate is secured to the license plate frame through the use of mechanical fasteners.

3. The license plate vacuum mount of claim 1 wherein the license plate is secured to the license plate frame through the use of magnets.

4. The license plate vacuum mount of claim 1 wherein the license plate is secured to the license plate frame through the use of adhesives.

5. The license plate vacuum mount of claim 1 wherein the license plate is secured to the license plate frame through the use of hook and loop material.

6. The license plate vacuum mount of claim 1 wherein the license plate frame is configured to provide a pouch, the pouch being configured to receive the insertion of the license plate.

7. The license plate vacuum mount of claim 1 wherein the license plate frame is a plate.

8. The license plate vacuum mount of claim 1 wherein the license plate frame is comprised of at least one bracket.

9. The license plate vacuum mount of claim 1 further including a cover.
